(19) United States
(12) Patent Application Publication
(10) Pub. No.: US 2025/0197596 A1
(43) Pub. Date: Jun. 19, 2025

(54) METHODS OF MANUFACTURE FOR THERMAL INTERFACE MATERIALS AND APPARATUSES USED THEREOF

(71) Applicant: Arieca Inc., Pittsburgh, PA (US)

(72) Inventors: Navid Kazem, Pittsburgh, PA (US); Vivek Singh, Pittsburgh, PA (US); Keyton D. Feller, Pittsburgh, PA (US); Dylan S. Shah, Pittsburgh, PA (US); Loren Russell, Pittsburgh, PA (US); Benjamin Dorau, Monroeville, PA (US); Hing Jii Mea, Pittsburgh, PA (US)

(21) Appl. No.: 18/893,191

(22) Filed: Sep. 23, 2024

Related U.S. Application Data
(60) Provisional application No. 63/612,041, filed on Dec. 19, 2023.

(51) Int. Cl. C08K 3/08; B04B 15/02

(52) U.S. Cl. CPC C08K 3/08; B04B 15/02; C08K 2201/001

(57) ABSTRACT

Methods of manufacture for thermal interface materials and apparatuses used therefor are provided. The method comprises combining a liquid metal and a polymer component to form an intermediate compound. A melting point of the liquid metal is no greater than 30 degrees Celsius. The intermediate compound is mixed in a vessel of a centrifugal mixer, thereby forming liquid metal droplets from the liquid metal and dispersing the liquid metal droplets throughout the polymer component. A temperature of the intermediate compound is controlled during mixing to be no greater than 30 degrees Celsius during the mixing and/or the vessel comprises an agitator.

### CROSS-REFERENCE

This application claims priority to U.S. Provisional Patent Application No. 63/612,041, which was filed on Dec. 19, 2023. The contents of which is hereby incorporated by reference into this specification.

### FIELD

The present disclosure relates to methods of manufacture for thermal interface materials and apparatuses used therefor.

### BACKGROUND

A thermal interface material (TIM) can be used to thermally connect two or more layers together. For example, TIMs are often used in CPU packages to thermally connect the integrated heat spreader (IHS) of a CPU package to a heat sink. There are various types of TIMs that can be used. However, current methods for producing TIMs present challenges.

### SUMMARY

In one general aspect, the present disclosure is directed to a method for producing a thermal interface material. The method comprises combining a liquid metal and a polymer component to form an intermediate compound. A melting point of the liquid metal is no greater than 30 degrees Celsius. The intermediate compound is mixed in a vessel of a centrifugal mixer, thereby forming liquid metal droplets from the liquid metal and dispersing the liquid metal droplets throughout the polymer component. A temperature of the intermediate compound is controlled during mixing to be no greater than 30 degrees Celsius during the mixing. In various examples, the liquid metal droplets comprise a D90 in a range of 1 micron to 300 microns. In certain examples, the liquid metal comprises at least one metal selected from the group consisting of gallium, a gallium alloy, indium, an indium alloy, tin, a tin alloy, mercury, and a mercury alloy. In various examples, the polymer component comprises a polymer selected from the group consisting of an acrylic polymer, an acrylate polymer, a vinyl polymer, a polyester polymer, a polyurethane polymer, a polybutadiene polymer, a polyamide polymer, a polyether polymer, a polysiloxane polymer, a silicon hydride polymer, a fluoropolymer, a polyisoprene polymer, and a copolymer of any two or more thereof.

In one general aspect, the present disclosure is directed to a method for producing a thermal interface material. The method comprises combining a liquid metal and a polymer component to form an intermediate compound. A melting point of the liquid metal is no greater than 30 degrees Celsius. The intermediate compound is mixed in a vessel of a centrifugal mixer, thereby forming liquid metal droplets from the liquid metal and dispersing the liquid metal droplets throughout the polymer component. The vessel comprises an agitator. In various examples, the vessel comprises a body defining a vessel cavity configured to receive the intermediate compound and a lid configured to detachably engage the body and operatively coupled to the agitator. In certain examples, the agitator further comprises a head disposed adjacent to the second end and the head extends radially outward from the shaft. In various examples, the liquid metal droplets comprise a D90 in a range of 1 micron to 300 microns. In certain examples, the liquid metal comprises at least one metal selected from the group consisting of gallium, a gallium alloy, indium, an indium alloy, tin, a tin alloy, mercury, and a mercury alloy. In various examples, the polymer component comprises a polymer selected from the group consisting of an acrylic polymer, an acrylate polymer, a vinyl polymer, a polyester polymer, a polyurethane polymer, a polybutadiene polymer, a polyamide polymer, a polyether polymer, a polysiloxane polymer, a silicon hydride polymer, a fluoropolymer, a polyisoprene polymer, and a copolymer of any two or more thereof.

In one general aspect, the present disclosure is directed to a centrifugal mixer comprising a housing, a vessel, a mount, and a motor. The housing defines a first longitudinal axis. The vessel is positioned within the housing and the vessel defines a second longitudinal axis. The mount is operatively coupled to the vessel and rotatably coupled to the housing. The motor is configured to revolve the vessel about the first longitudinal axis and rotate the vessel about the second longitudinal axis. The vessel comprises an agitator. In various examples, the vessel comprises a body defining a vessel cavity and a lid configured to detachably engage the body and operatively coupled to the agitator.

The present disclosure can provide efficient manufacturing of TIMs, enhanced uniformity of TIMs, and/or enhanced particle size if liquid metal droplets in TIMs. These and other benefits realizable from various embodiments of the present invention will be apparent from the description that follows.

### BRIEF DESCRIPTION OF THE DRAWINGS

The features and advantages of various examples of the present invention, and the manner of attaining them, will become more apparent, and the examples will be better understood by reference to the following description of examples taken in conjunction with the accompanying drawing, wherein:

FIG. 1 is a schematic representation of a centrifugal mixer according to the present disclosure;

FIG. 2 is a flow diagram of a method for producing a thermal interface material according to the present disclosure;

FIG. 3 is a schematic representation of a vessel according to the present disclosure;

FIG. 4A is a schematic representation of a vessel and a head of an agitator according to the present disclosure;

FIG. 4B is a schematic representation of a vessel and a head of an agitator according to the present disclosure;

FIG. 4C is a schematic representation of a vessel and a head of an agitator according to the present disclosure;

FIG. 4D is a schematic representation of a vessel and a head of an agitator according to the present disclosure;

FIG. 4E is a schematic representation of a vessel and a head of an agitator according to the present disclosure;

FIG. 4F is a schematic representation of a vessel and a head of an agitator according to the present disclosure;

FIG. 4G is a schematic representation of a vessel and a head of an agitator according to the present disclosure; and

FIG. 5 is a schematic representation of a vessel comprising multiple mixing zones according to the present disclosure.

Corresponding reference characters indicate corresponding parts throughout the several views. The exemplifications set out herein illustrate certain examples, in one form, and such exemplifications are not to be construed as limiting the scope of the examples in any manner.

### DETAILED DESCRIPTION

Certain exemplary aspects of the present invention will now be described to provide an overall understanding of the principles of the manufacture of TIMs and apparatuses for manufacture disclosed herein. An example or examples of these aspects are illustrated in the accompanying drawing. Those of ordinary skill in the art will understand that the methods and apparatuses specifically described herein and illustrated in the accompanying drawing are non-limiting exemplary aspects and that the scope of the various examples of the present invention is defined solely by the claims. The features illustrated or described in connection with one exemplary aspect may be combined with the features of other aspects. Such modifications and variations are intended to be included within the scope of the present invention.

Current method of manufacturing thermal interface materials (TIMs) can require balancing batch size and mixing duration. For example, when increasing batch size, dispersing liquid metal droplets in a polymeric component using a centrifugal mixer may require increasing mixing times to achieve a desired distribution of liquid metal droplets, especially when higher viscosity TIMs are required in an application. Additionally, the present inventors have determined that excess heat generated in TIM manufacturing due to both longer mixing times and high viscosity polymer components may result in temperatures approaching or exceeding cure temperatures, thereby increasing the likelihood of prematurely curing the polymer components prior to desirably dispersing liquid metal droplets therein. Additionally, the present inventors have also determined that when producing TIM compositions, pockets or regions of unmixed components may form in a dual-axis mixer during mixing and the issue may increase as batch size increases.

The present disclosure provides methods for producing a TIM that can efficiently manufacture TIMs, enhance uniformity of TIMs, and enhance particle size of TIMs regardless of viscosity and/or batch size. The method comprises combining a liquid metal and a polymer component to form an intermediate compound. The intermediate compound is mixed in a vessel of the centrifugal mixer, thereby forming liquid metal droplets from the liquid metal and dispersing the liquid metal droplets throughout the polymer component. A temperature of the intermediate compound can be controlled to be no greater than 30 degrees Celsius during the mixing and/or the vessel can include an agitator.

The present disclosure also provides a centrifugal mixer comprising a housing, a vessel, a mount, and a motor. The housing defines a first longitudinal axis. The vessel is positioned within the housing and the vessel defines a second longitudinal axis. The mount is operatively coupled to the vessel and rotatably coupled to the housing. The motor is configured to revolve the vessel about the first longitudinal axis and rotate the vessel about the second longitudinal axis. The vessel comprises an agitator. In various examples, the vessel comprises a body defining a vessel cavity and a lid configured to detachably engage the body and operatively coupled to the agitator. The methods and apparatus described herein can disrupt uneven flow patterns and/or pockets of unmixed liquid metal to promote more homogeneous mixing throughout the TIM, decrease mixing time required to successfully disperse liquid metals, and/or promote uniformity of the dispersed liquid metal droplets in TIMs.

As used in this specification, the terms “polymer” and “polymeric” means prepolymers, oligomers, and both homopolymers and copolymers. As used in this specification, “prepolymer” means a polymer precursor capable of further reactions or polymerization by a reactive group or reactive groups to form a higher molecular mass and/or cross-linked state.

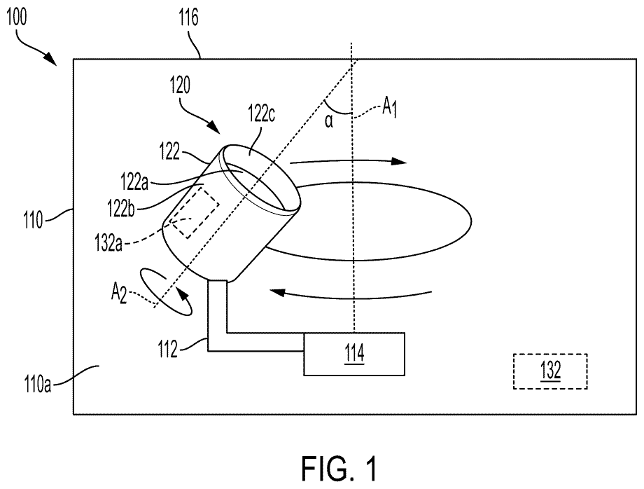

As described herein, the centrifugal mixers employed in the methods according to the present disclosure can be dual axis centrifugal mixers. Referring to FIG. 1, a centrifugal mixer 100 is provided, which can mix materials and manufacture a suitable TIM. The centrifugal mixer 100 can comprise a housing 110, a vessel 120 disposed within a cavity 110a of the housing 110, a mount 112 rotatably coupled to the vessel 120 and housing 110, and a motor 114. The housing 110 defines a first longitudinal axis, A₁ and the vessel 120 defines a second longitudinal axis, A₂. The centrifugal mixer 100 can be a dual axis centrifugal mixer (e.g., planetary centrifugal mixer) such that the vessel 120 can be revolved about the first longitudinal axis, A₁, and rotated about the second longitudinal axis, A₂, thereby inducing shear and flow to a material within the vessel 120.

As illustrated, the housing 110 defines the cavity 110a therein. The housing 110 can comprise a shape suitable to enclose the vessel 120. In certain examples, the housing 110 can comprise a lid 116 suitable to enable an operator to access the vessel 120 when in an open position and enable an air tight seal when in the close position. The housing 110 can be air-tight such that pressure within the housing 110 can be controlled (e.g., a vacuum may be applied to the cavity 110a).

The motor 114 is configured to revolve the vessel 120 about the first longitudinal axis, A₁, and rotate the vessel 120 about the second longitudinal axis, A₂. The revolutions about the first longitudinal axis, A₁, may be clockwise or counter clockwise. The rotations about the second longitudinal axis, A₂, may be clockwise or counter clockwise. The revolutions and rotations may be in the same direction or different directions. The motor 114 can comprise various output shafts and gearing as the application may require. Even though a single motor 114 is illustrated, it is understood that the functions of the motor 114 may be implemented by a single motor or two or more motors.

The motor 114 and the vessel 120 may be operably coupled together via the mount 112. The mount 112 may comprise or a separate component operatively coupled to the mount 112 may comprise a gear train to enable rotation and revolution of the vessel 120. For example, the mount 112 can synchronize rotation of an output shaft of the motor 114 with a rotation of the vessel 120 about the second longitudinal axis, A₁ and revolution of the vessel 120 about the first longitudinal axis, A₁. The mount 112 can be mechanically coupled to the vessel 120. The mount 112 can support the pose (e.g., position and orientation) of the vessel 120. In certain examples, the vessel 120 may be removable from the mount 112.

The vessel 120 can be positioned by the mount 112 such that the second longitudinal axis, A₂, can be tilted at an angle, α, relative to the first longitudinal axis, A₁. For example, the angle, α, may be in a range of 10 degrees to 90 degrees, such as, for example, 20 degrees to 80degrees, 30 degrees to 60 degrees, or 40 degrees to 50 degrees. The angle, a, may be selected as the application may require for dispersing liquid metal droplets throughout a polymer component. In various examples, the angle, α, is 45 degrees.

The vessel 120 can comprise a body 122 as illustrated in FIG. 1. The body 122 can comprise an outer surface 122b directed towards the cavity 110a of the housing 110 and an inner surface 122c defining the cavity 120a. The vessel 120 can be substantially cylindrical shaped and can be sized as desired depending on the application and quantity of material to be mixed within the vessel. For example, the vessel 120 can be configured with a volume of at least 100 mL, at least 1 liter, at least 2 liters, at least 5 liters, at least 10 liters, at least 100 liters, or at least 1,000 liters. In various examples, the vessel 120 can be configured with a volume in a range of 100mL to 10,000 liters, such as, for example, 1 liter to 1,000 liters.

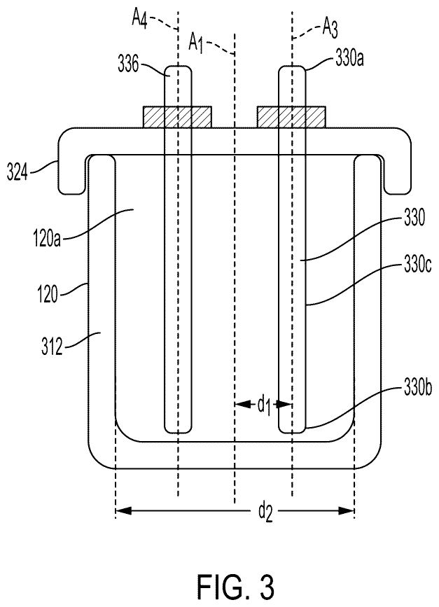

The vessel 120 can comprise a material compatible with the contents to be mixed therein, such as, for example, the TIM or a component of the TIM (e.g., liquid metal). For example, the vessel 120, including the body 122, can comprise a metal, a metal alloy (e.g., stainless steel), a polymer, or any combination thereof. In certain examples, the body 122 can be thermally conductive. For example, the body 122 can comprise a metal or a metal alloy. In various examples, the vessel 120 may comprise a lid configured to detachably engage the body 122 and/or an agitator 330 as described with reference to FIGS. 3, FIGS. 4A-4G, and FIG. 5 below.

The centrifugal mixer 100 can optionally comprise a temperature control system 132 in thermal communication with the vessel 120. The temperature control system 132 can comprise a single component or be made of two more components as the application may require. The temperature control system 132 can control a temperature of the cavity 120a of the vessel 120 by either direct contact or indirect contact. For example, the temperature control system 132 can control the temperature within the cavity 110a of the housing 110 and/or the temperature control system 132 can be placed in direct contact with the vessel 120 as shown at location 132a to directly control a temperature of the body 122 of the vessel 120.

The temperature control system 132 can comprise an active temperature control system based on various mechanisms of action, such as, for example, thermoelectric and/or vapor-compression based temperature control. The temperature control system 132 may comprise a forced air cooler, a convection cooler, a Peltier device, a different temperature control device, or a combination thereof. In certain examples, the temperature control system 132 can comprise a forced air cooler for indirect cooling of the vessel 120. In various examples, the temperature control system 132 at location 132a can comprise a Peltier device in thermal communication with the body 122 of the vessel 120 to directly control the temperature thereof.

The temperature control system 132 can be configured to control a temperature distribution throughout the cavity 120a of the vessel 120. For example, the temperature control system 132 at location 132a may comprise a distributed array of independently controlled Peltier devices in thermal communication with the body 122 of the vessel 120. The temperature control system 132 may comprise various components, such as, for example, a temperature sensor, a fan, a Peltier cooler, a compressor, an evaporation coil, a condensation coil, a heater, piping, a heat sink, an evaporative heat pipe, a hardware controller, a feedback system, other components, or any combination thereof.

The vessel 120 can optionally comprise an agitator. For example, referring to FIG. 3, the vessel 120 comprises an agitator 330. The agitator 330 can be a structural member configured to be positioned within the cavity 120a of the vessel 120 in order to redirect and/or perturb flow of the intermediate compound during mixing, thereby enabling more efficient mixing to form the TIM. The agitator 330 can comprise a metal, a metal alloy, a polymer, or a combination thereof.

The present inventors have determined that when producing TIMs in a centrifugal mixer, regions of intermediate compound may become resistant to uniform mixing and may not experience a desired level of shear during mixing. Disrupting these regions can enable more homogeneous mixing throughout the intermediate compound, thereby forming an enhanced uniformity in a TIM produced therefrom and/or an enhanced particle size control in the liquid metal droplets in the TIM.

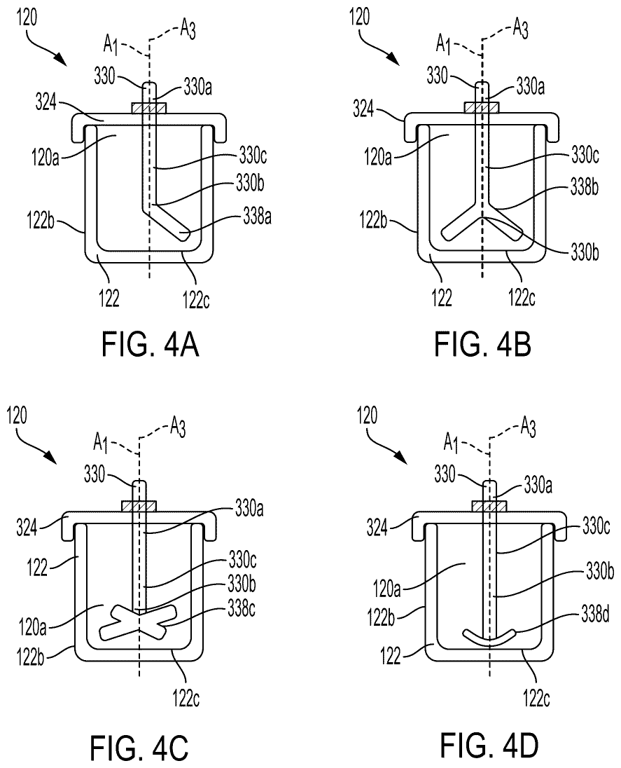

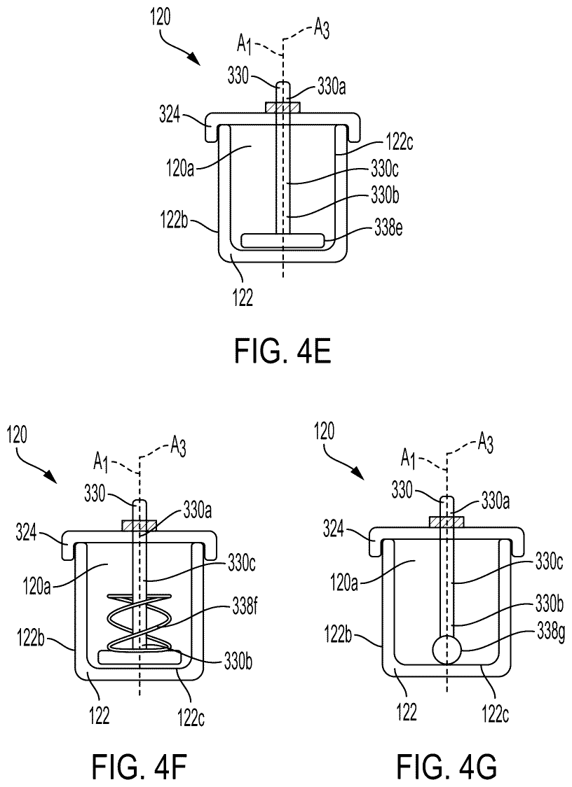

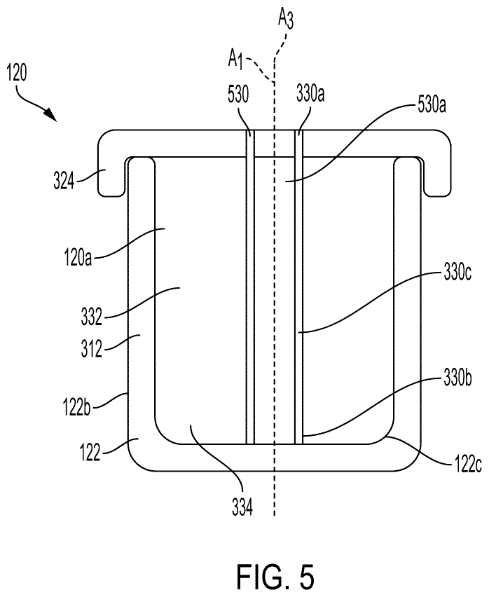

The agitator 330 defines a third longitudinal axis, A₃. The third longitudinal axis, A₃, of the agitator 330 may be offset with respect to the second longitudinal axis, A₂, of the vessel 120 by a distance, d₁. For example, the distance, d₁, can be at least 1% of the distance of the diameter, d₂, of the vessel 120, such as, for example, at least 5%, at least 10%, at least 20%, at least 25%, at least 30%, at least 40%, at least 45%, or at least 49% of the diameter, d₂. In various examples, the third longitudinal axis, A₃, of the agitator 330 may not be offset with respect to the second longitudinal axis, A₂, as shown in FIGS. 4A-4G and FIG. 5 as described below.

Referring back to FIG. 3, the vessel 120 can comprise a single agitator 330, or the vessel 120 can comprise at least two agitators. For example, the vessel 120 can comprise agitator 330 and a second agitator 336 defining a fourth longitudinal axis, A₄, which may also be offset with respect to the second longitudinal axis, A₂. The second agitator 336 may be configured the same as agitator 330 or the second agitator 336 can be different from the agitator 330.

The vessel 120 comprises the body 122 and optionally the vessel 120 comprises a lid 324 configured to detachably engage the body 122 and enclose the cavity 120a therein. For example, the body 122 and the lid 324 may be configured to be threaded, friction fit, and/or magnetically coupled to each other. The agitator 330 can comprise a first end 330a, a second end 330b, and a shaft 330c extending from the first end 330a to the second end 330b. The first end 330a can be operatively coupled to the lid 324 by, for example, an adhesive, a weld, a friction fit, a threaded engagement, or a combination thereof. In various examples, the agitator 330 can be operatively coupled to the body 122 in addition to or instead of the lid 324.

The agitator 330 may comprise actively driven components to rotate about the third longitudinal axis, A₃, or the agitator 330 may be stationary with respect to the vessel 120 and the third longitudinal axis, A₃. For example, the first end 330a may be mechanically fixed to the lid 324 such that the agitator 330 revolves about the second longitudinal axis, A₂, at the same rate as the vessel 120. The agitator 330 may perturb the flow of the intermediate compound during mixing without independently rotating the agitator 330 about the third longitudinal axis, A₃. Alternatively, the agitator 330 may rotate about the third longitudinal axis, A₃. For example, the agitator 330 may be rotatably coupled to the lid 324. In various examples, the agitator 330 may be independently rotated by a motor.

Referring to FIGS. 4A-4G, the agitator 330 can comprise a head 338a disposed adjacent to the second end 330b and the head 338 can extend radially outward from the shaft and the longitudinal axis, A₃towards the body 122 of the vessel 120. The head 338a can comprise various geometries, such as a paddle as illustrated by head 338a in FIG. 4A, a dual paddle as illustrated by head 338b in FIG. 4B, a x-shaped paddle as illustrated by head 338c in FIG. 4C, a cup-shaped paddle as illustrated by head 338d in FIG. 4D, a disc as illustrated by head 338e in FIG. 4E, a ribbon as illustrated by head 338f in FIG. 4F, and/or a ball as illustrated by head 338g in FIG. 4G as desired depending on the desired application. The head 338a may or may not comprise holes. The selection of the desired shape can be application dependent. For example, there can be a balance of mix quality, yield, and/or compatibility when selecting the desirable shape.

The agitator 330 may be a tubular and can be configured to maintain a first mixing zone and a separate second mixing zone within the vessel 120. For example, referring to FIG. 5, the vessel 120 can comprise an agitator 530 defining a cavity 530a therein. The cavity 530a can be separated from a portion 334 of the remainder of cavity 120a such that material present in the cavity 530a is separated from the portion 334 (e.g., liquid communication is inhibited). The agitator 530 can enable different degrees of mixing within the same vessel 120. For example, material within cavity 530a may be subjected to a lower shear than material within portion 334, which can lead to a multi-modal particle size of liquid metal droplets formed within the vessel 120. Upon removal of the lid 324 and agitator 530, material in cavity 530a and in portion 334 may be mixed together to form the TIM.

Referring again to FIG. 3, the agitator 330 may be configured to exchange heat with an intermediate compound in the cavity 120a and the environment outside of the vessel 120. For example, the agitator 330 may be a heat sink and/or an evaporative heat pipe. In various examples, the agitator 330 can be comprised of a thermally conductive material, such as a metal or metal alloy (e.g., iron alloys such as stainless, nickel alloys). In certain examples, the first end 330a of the agitator 330 may extend beyond the lid 324 to exchange heat with the cavity 120a of the vessel 120 or other component. In various examples, the agitator 330 can comprise a high surface area, such as, for example, a textured surface and/or a finned surface.

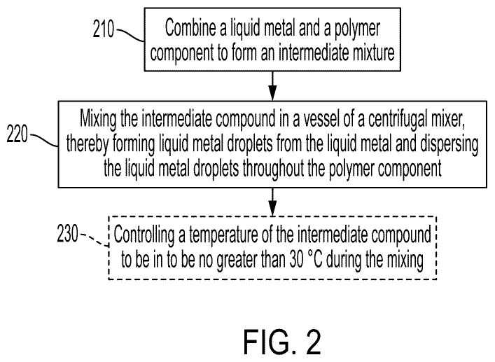

Referring to FIG. 2, a method for producing a thermal interface material is provided. The method comprises combining a liquid metal and a polymer component to form an intermediate compound at step 210. The combination of the liquid metal and the polymer may occur in the cavity 120a of the vessel 120, in a container prior to addition to the vessel 120, or a combination thereof. The combination of the liquid metal and the polymer may be performed at a temperature no greater than 30 degrees Celsius.

The polymer component can comprise a polymeric binder, a thermosetting polymer, and/or a thermoplastic polymer. As used herein, the term “thermosetting” refers to polymers that “set” irreversibly upon curing or cross-linking, where the polymer chains of the polymeric components are joined together by covalent bonds, which is often induced, for example, by heat or radiation. In various examples, curing or a cross-linking reaction can be carried out under ambient conditions. Once cured or cross-linked, a thermosetting polymer may not flow upon the application of heat, may otherwise irreversibly increase in viscosity, and/or can be insoluble in conventional solvents. As used herein, the term “thermoplastic” refers to polymers that include polymeric components in which the constituent polymer chains are not joined (e.g., crosslinked) by covalent bonds and thereby can undergo liquid flow upon heating and are soluble in conventional solvents. In certain embodiments, the polymer can be elastomeric (e.g., rubbery, soft, stretchy), or rigid (e.g., glassy) For example, the polymer component can be elastomeric and may have a ultimate tensile strain of at least 100%, such as, for example at least 200% or at least 300%. Ultimate tensile strain can be measured according to ASTM D3039.

Thermosetting polymers may include at least one of a cross-linking agent that may comprise, for example, aminoplasts, polyisocyanates (including blocked isocyanates), polyepoxides, beta-hydroxyalkylamides, polyacids, anhydrides, organometallic acid-functional materials, polyamines, polyvinyls, polysilicon hydrides, polyalcohols, polyacid chlorides, polyhalides, and polyamides. A polymer may have functional groups that are reactive with the cross-linking agent.

The polymer component described herein may be selected from any of a variety of polymers well known in the art. For example, the thermosetting polymer may comprise at least one of an acrylic polymer (e.g., an acrylate polymer), a vinyl polymer, a polyester polymer, a polyurethane polymer, polybutadiene, a polyamide polymer, a polyether polymer, a polysiloxane polymer (e.g., poly (dimethylsiloxone)), a silicon hydride polymer, a fluoropolymer, a polyisoprene polymer (e.g., rubber), and a copolymer of two or more thereof. The functional groups on a thermosetting polymer may be selected from any of a variety of reactive functional groups, including, for example, at least one of a carboxylic acid group, an amine group, an epoxide group, a hydroxyl group, a thiol group, a carbamate group, an amide group, a urea group, an isocyanate groups (including a blocked isocyanate group), a vinyl group, a silicon hydride group, an acid chloride group, an acrylate group, a halide group, and a mercaptan group.

The thermoplastic polymer can comprise at least one of propylene-ethylene co-polymer, styrene-butadiene-styrene, and styrene ethylene butylene styrene. The polymer can comprise a melting point of at least 100 degrees Celsius, such as, for example, at least 120 degrees Celsius, at least 150 degrees Celsius, or at least 200 degrees Celsius.

The polymeric binder can be a polyether binder.

In various examples, the polymer component can comprise 0.1% by to 0.5% by weight of a coupling agent based on a total weight of the polymer component. For example, the coupling agent can comprise at least one of 3-Glycidoxypropyltrimethoxysilane, 3-Glycidoxypropyltriethoxysilane, 3-Aminopropyltrimethoxysilane, and Bis(3-trimethoxysilylpropyl)amine.

In certain examples, the polymer component can comprise 0.1% by weight to 5% by weight of a fumed silica based on a total weight of the polymer component.

The intermediate compound can comprise at least 5% polymer component by total volume of the intermediate compound, such as, for example, at least 7% polymer component, at least 10% polymer component, at least 15% polymer component, at least 20% polymer component, at least 25% polymer component, at least 30% polymer component, at least 40% polymer component, at least 50% polymer component, or at least 60% polymer component, all based on the total volume of the intermediate compound. The intermediate compound can comprise no greater than 99% polymer component by total volume of the intermediate compound, such as, for example, no greater than 80% polymer component, no greater than 60% polymer component, no greater than 50% polymer component, no greater than 40% polymer component, no greater than 30% polymer component, no greater than 25% polymer component, no greater than 20% polymer component, no greater than 15% polymer component, or no greater than 10% polymer component, all based on the total volume of the intermediate compound. The intermediate compound can comprise a range of 5% to 99% polymer component by total volume of the intermediate compound, such as, for example, 5% to 80% polymer component, 5% to 60% polymer component, 5% to 50% polymer component, 5% to 40% polymer component, 5% to 30% polymer component, 7% to 30% polymer component, 10% to 30% polymer component, 5% to 25% polymer component, or 5% to 20% polymer component, all based on the total volume of the intermediate compound. The amount of the polymer component can be selected while balancing a desired elasticity, adhesiveness, and a desired effective thermal conductivity of the TIM to be formed from the intermediate compound.

The liquid metal can comprise at least one of gallium, a gallium alloy, indium, an indium alloy, tin, a tin alloy, mercury, and a mercury alloy. The liquid metal can comprise a melting point of no greater than 30 degrees Celsius, such as, for example, no greater than 25 degrees Celsius, no greater than 20 degrees Celsius, no greater than 15 degrees Celsius, no greater than 10 degrees Celsius, no greater than 5 degrees Celsius, no greater than 0 degrees Celsius, or no greater than −10 degrees Celsius. The liquid metal can comprise a melting point of at least −40 degrees Celsius, such as, for example, at least −20 degrees Celsius, at least −19 degrees Celsius, at least −10 degrees Celsius, at least 0 degrees Celsius, at least 5 degrees Celsius, at least 10 degrees Celsius, at least 15 degrees Celsius, at least 20 degrees Celsius, or at least 25 degrees Celsius. The liquid metal can comprise a melting point in a range of −40 degrees Celsius to 30 degrees Celsius, such as, for example, −20 degrees Celsius to 30 degrees Celsius, −19 degrees Celsius to 30 degrees Celsius, or −19 degrees Celsius to 25 degrees Celsius. The determination of the melting point can be made at a pressure of 1 atmosphere absolute. In certain embodiments, the liquid metal can comprise Gallium Indium Tin (Galinstan) and a melting point of −19 degrees Celsius.

The intermediate compound can comprise at least 1% liquid metal by total volume of the intermediate compound, such as, for example, at least 5% liquid metal, at least 10% liquid metal, at least 20% liquid metal, at least 30% liquid metal, at least 40% liquid metal, at least 50% liquid metal, at least 60% liquid metal, at least 70% liquid metal, at least 80% liquid metal, or at least 90% liquid metal, all based on the total volume of the intermediate compound. The TIM can comprise no greater than 95% liquid metal by total volume of the intermediate compound, such as, for example, no greater than 93% liquid metal, no greater than 90% liquid metal, no greater than 80% liquid metal, no greater than 70% liquid metal, no greater than 60% liquid metal, no greater than 50% liquid metal, no greater than 40% liquid metal, no greater than 30% liquid metal, no greater than 20% liquid metal, or no greater than 10% liquid metal, all based on the total volume of the intermediate compound. The intermediate compound can comprise a range of 1% to 95% liquid metal by total volume of the intermediate compound, such as, for example, 5% to 93% liquid metal, 40% to 95% liquid metal, 50% to 95% liquid metal, 50% to 93% liquid metal, 60% to 93% liquid metal, 70% to 95% liquid metal, or 70% to 93% liquid metal, all based on the total volume of the intermediate compound. The amount of liquid metal can be selected while balancing a desired elasticity and a desired effective thermal conductivity of the TIM to be formed from the intermediate compound.

Referring again to FIG. 2, the method comprises mixing the intermediate compound in the vessel 120 of the centrifugal mixer 100, thereby forming liquid metal droplets from the liquid metal and dispersing the liquid metal droplets throughout the polymer component at step 220. Step 220 can result in formation of the TIM. Mixing at step 220 can comprise revolving the vessel 120 about the first longitudinal axis, A₁, at a first rate, and rotating the vessel 1120 about the second longitudinal axis, A₂, at a second rate. The first rate can be in a range of 100 rpm to 10,000 rpm, such as, for example, 200 rpm to 5,000 rpm, 300 rpm to 4,000 rpm, 500 rpm to 3,000 rpm, 1,000 rpm to 3,000 rpm, or 1,500 rpm to 2,500 rpm. The second rate can be in a range of 10 rpm to 10,000 rpm, such as, for example, 20 rpm to 5,000 rpm, 30 rpm to 4,000 rpm, 100 rpm to 3,000 rpm, 200 rpm to 2,000 rpm, 400 rpm to 1,200 rpm, or 600 rpm to 100 rpm. The mixing can be performed for at least 10 seconds, such as, for example, at least 1 minute, at least 5 minutes, at least 10 minutes, at least 20 minutes, at least 30 minutes, at least 40 minutes, at least 50 minutes, or at least 1 hour. In various examples, the mixing can be performed for a time in a range of 10 seconds to 12 hours, such as, for example, 1 minute to 10 hours, 10 minutes to 8 hours, 20 minutes to 6 hours, 30 minutes to 4 hours, or 30 minutes to 2 hours.

The composition and/or mixing techniques can be selected to achieve a desired D₅₀ and/or D₉₀ of the liquid metal droplets in the TIM prior to compressing in an assembly. The D₅₀ of the liquid metal droplets can be at least 1 micron prior to compressing, such as, for example, at least 5 microns, at least 10 microns, at least 15 microns, at least 20 microns, at least 30 microns, at least 35 microns, at least 40 microns, at least 50 microns, at least 60 microns, at least 70 microns, at least 80 microns, at least 90 microns, at least 100 microns, at least 120 microns, at least 150 microns, or at least 200 microns, all prior to compressing. The D₅₀ of the liquid metal droplets can be no greater than 300 micron, such as, for example, no greater than 250 microns, no greater than 200 microns, no greater than 150 microns, no greater than 120 microns, no greater than 100 microns, no greater than 90 microns, no greater than 80 microns, no greater than 70 microns, no greater than 60 microns, no greater than 50 microns, no greater than 40 microns, no greater than 35 microns, no greater than 30 microns, no greater than 20 microns, no greater than 10 microns, or no greater than 5 microns, all prior to compressing in an assembly. For example, the D₅₀ of the liquid metal droplets can be in a range of 1 microns to 300 microns, such as, for example, 5 microns to 300 microns, 150 microns to 250 microns, 5 microns to 150 microns, 15 to 150 microns, 35 microns to 150 microns, 35 microns to 70 microns, or 5 microns to 100 microns, all measured prior to compressing in an assembly.

As used herein, Dx can be measured using microscopy (e.g., optical microscopy or electron microscopy). The size can be the diameter of spherical particles or the length along the largest dimension of ellipsoidal or otherwise irregularly shaped particles. As used herein, “Dx” of particles refers to the diameter at which X% of the particles have a smaller diameter.

The Doo of the liquid metal droplets can be at least 1 micron, such as, for example, at least 5 microns, at least 10 microns, at least 15 microns, at least 20 microns, at least 30 microns, at least 35 microns, at least 40 microns, at least 50 microns, at least 60 microns, at least 70 microns, at least 80 microns, at least 90 microns, at least 100 microns, at least 120 microns, at least 150 microns, or at least 200 microns, all prior to compressing in an assembly. The D₉₀ of the liquid metal droplets can be no greater than 300 micron, such as, for example, no greater than 250 microns, no greater than 200 microns, no greater than 150 microns, no greater than 120 microns, no greater than 100 microns, no greater than 90 microns, no greater than 80 microns, no greater than 70 microns, or no greater than 50 microns, all prior to compressing in an assembly. For example, the D₉₀ of the liquid metal droplets can be in a range of 1 microns to 300 microns, such as, for example, 5 microns to 300 microns, 150 microns to 250 microns, 10 microns to 200 microns, 15 to 150 microns, 35 microns to 150 microns, 35 microns to 120 microns, or 50 microns to 100 microns, all measured prior to compressing in an assembly.

The composition and/or mixing techniques can be chosen such that the viscosity of the TIM is no greater than 2,000,000 cP (centipoise), such as, for example, no greater than 750,000 cP, no greater than 500,000 cp, no greater than 250,000 cP, 200,000 cP, no greater than 150,000 cP, no greater than 100,000 cP, no greater than 50,000 cP, no greater than 15,000 cP, no greater than 14,000 cP, no greater than 13,000 cP, no greater than 12,000 cP, no greater than 11,000 cP, or no greater than 10,000 cP. For example, the composition and/or mixing techniques can be chosen such that the viscosity of the TIM is at least 1,000 cP, such as, for example, at least 2,000 cP, at least 5,000 cP, or at least 10,000 cP. The composition and/or mixing techniques can be chosen such that the viscosity of the TIM is in a range of 1,000 cP to 2,000,000 cP, such as, for example, 2,000 cP to 750,000 cP, or 2,000 cP to 500,000 cP. The viscosity of the TIM emulsion can be measured by a parallel plate (40 mm) rheometer at 25 degrees Celsius, a frequency of 10 radians per second, and a strain of 5%.

Referring again to FIG. 2, at step 230, the method can optionally comprise controlling a temperature of the intermediate compound to be no greater than 30 degrees Celsius during the mixing. In certain examples, the temperature of the intermediate compound is controlled to be in a temperature range of −40 degrees Celsius to 30 degrees Celsius during the mixing, such as, for example, −20 degrees Celsius to 30 degrees Celsius, −10 degrees Celsius to 30 degrees Celsius, 1 degree Celsius to 30 degrees Celsius, 0 degrees Celsius to 25 degrees Celsius, or 1 degrees Celsius to 25 degrees Celsius. Step 230 can be performed by the temperature control system 132.

Controlling a temperature of the intermediate compound during the mixing can maintain the physical properties of the liquid metal and the polymer component for forming a dispersion while balancing the heat generated during mixing associated with larger batch sizes (e.g., at least 0.5 kilograms (kg), at least 1 kilogram, at least 10 kg, at least 100 kg, at least 1000 kg), high viscosity polymer components, and/or mixing times exceeding 10 seconds, such as, for example, times exceeding 1 minute, 5 minutes, 10 minutes, 20 minutes, 30 minutes, 40 minutes, or 1 hour. The method according to the present disclosure can inhibit, if not eliminate, premature thickening and/or curing of the polymer component, thereby optimizing efficient manufacture of the TIM.

The method can optionally comprise removing the intermediate compound and/or the vessel 120 and/or mixed intermediate compound therein from the centrifugal mixer 100 after mixing for a downstream process which may include packaging the TIM, forming a secondary composition, and/or applying the TIM layer onto a device or circuit assembly. For example, the TIM can be applied intermediate to a first layer and a second layer of an assembly at a first thickness. The assembly can be compress to degrees the first thickness to a second thickness, wherein the second thickness is no greater than a D₉₀ of the liquid metal droplets in the thermal interface material prior to compressing the assembly. After compressing the assembly, the TIM can be cured. The assembly can comprise a heat-generating electronic component (e.g., a battery, memory, a data storage unit, a power inverter, a thermoelectric generator, a motor winding, an integrated circuit), a processor (e.g., central processing unit (CPU), tensor processing unit (TPU), graphics processing unit (GPU), artificial intelligence focused processor, an ASIC, a system-on-a-chip (SOC)), a heat sink (e.g., fins, fan, liquid cooling, cold plate, heat sink, heat wick, heat pipe), an integrated heat spreader, and packaging.

More details about exemplary ways to apply TIMs are described in (1) published PCT WO/2019/136252, entitled “Method of Synthesizing a Thermally Conductive and Stretchable Polymer Composite”, (2) published U.S. application US 2017/0218167, entitled “Polymer Composite with Liquid Phase Metal Inclusions,” (3) U.S. Pat. No. 10,777,483, entitled “Method, apparatus, and assembly for thermally connecting layers”, (4) U.S. Provisional Patent No. 63/268,134 entitled “Thermal interface material, an integrated circuit assembly, and a method for thermally connecting layers”, (5) published PCT WO 2022/204689 entitled “A method, apparatus, and assembly for thermally connecting layers with thermal interface materials comprising rigid particles”, and (6) U.S. provisional application 63/479,879, entitled “A method of Manufacture of a Thermal Interface Material, a Thermal Interface Material Formed Therefrom, and an Integrated Circuit Formed Therefrom”, all of which are incorporated herein by reference in their entirety.

Those skilled in the art will recognize that the herein described compositions, articles, methods, and the discussion accompanying them are used as examples for the sake of conceptual clarity and that various configuration modifications are contemplated. Consequently, as used herein, the specific examples set forth and the accompanying discussion are intended to be representative of their more general classes. In general, use of any specific exemplar is intended to be representative of its class, and the non-inclusion of specific components (e.g., operations), devices, and objects should not be taken as limiting.

With respect to the appended claims, those skilled in the art will appreciate that recited operations therein may generally be performed in any order. Also, although various operational flows are presented in a sequence(s), it should be understood that the various operations may be performed in other orders than those that are illustrated or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

Although various examples have been described herein, many modifications, variations, substitutions, changes, and equivalents to those examples may be implemented and will occur to those skilled in the art. Also, where materials are disclosed for certain components, other materials may be used. It is therefore to be understood that the foregoing description and the appended claims are intended to cover all such modifications and variations as falling within the scope of the disclosed examples. The following claims are intended to cover all such modification and variations.

Various aspects of the invention according to the present disclosure include, but are not limited to, the aspects listed in the following numbered clauses.

Clause 1. A method for producing a thermal interface material, the method comprising: combining a liquid metal and a polymer component to form an intermediate compound, wherein a melting point of the liquid metal is no greater than 30 degrees Celsius; mixing the intermediate compound in a vessel of a centrifugal mixer, thereby forming liquid metal droplets from the liquid metal and dispersing the liquid metal droplets throughout the polymer component; and controlling a temperature of the intermediate compound to be no greater than 30 degrees Celsius during the mixing.

Clause 2. The method of clause 1, wherein controlling the temperature of the intermediate compound comprises cooling.

Clause 3. The method of any of clauses 1-2, wherein controlling the temperature of the intermediate compound is performed by controlling a temperature of a wall of the vessel.

Clause 4. The method of clause 3, wherein controlling a temperature of the wall of the vessel comprises solid state cooling the wall of the vessel.

Clause 5. The method of any of clauses 3-4, wherein the wall of the vessel is metallic.

Clause 6. The method of any of clauses 1-5, wherein the centrifugal mixer comprises a cavity and the vessel is disposed within the cavity, wherein controlling the temperature comprises controlling a temperature of the cavity.

Clause 7. The method of clause 6, wherein controlling the temperature of the fluid comprises forced air cooling.

Clause 8. The method of any of clauses 1-7, wherein the intermediate compound is in a temperature range of 0 degrees Celsius to 30 degrees Celsius during the mixing.

Clause 9. The method of any of clauses 1-8, wherein the thermal interface material comprises a viscosity in a range of 1,000 cP to 2,000,000 cP measured at 25 degrees Celsius.

Clause 10. The method of any of clauses 1-9, wherein the liquid metal comprises at least one metal selected from the group consisting of gallium, a gallium alloy, indium, an indium alloy, tin, a tin alloy, mercury, and a mercury alloy.

Clause 11. The method of any of clauses 1-10, wherein the polymer component comprises a polymer selected from the group consisting of an acrylic polymer, an acrylate polymer, a vinyl polymer, a polyester polymer, a polyurethane polymer, a polybutadiene polymer, a polyamide polymer, a polyether polymer, a polysiloxane polymer, a silicon hydride polymer, a fluoropolymer, a polyisoprene polymer, and a copolymer of any two or more thereof.

Clause 12. The method of any of clauses 1-11, wherein the liquid metal droplets comprise a D₉₀ in a range of 1 micron to 300 microns.

Clause 13. The method of any of clauses 1-12, wherein the vessel comprises an agitator.

Clause 14. The method of any of clauses 1-13, wherein the centrifugal mixer is a dual axis centrifugal mixer.

Clause 15. A method for producing a thermal interface material, the method comprising: combining a liquid metal and a polymer component to form an intermediate compound, wherein a melting point of the liquid metal is no greater than 30 degrees Celsius; and mixing the intermediate compound in a vessel of a centrifugal mixer, thereby forming liquid metal droplets from the liquid metal and dispersing the liquid metal droplets throughout the polymer component, wherein the vessel comprises an agitator.

Clause 16. The method of clause 15, wherein the vessel comprises a body defining a vessel cavity configured to receive the intermediate compound and a lid configured to detachably engage the body, and the agitator is operatively coupled to the lid.

Clause 17. The method of any of clauses 15-16, wherein the agitator comprises a first end, a second end, and a shaft extending from the first end to the second end, wherein the first end is operatively coupled to the lid.

Clause 18. The method of clause 17, wherein the agitator further comprises a head disposed adjacent to the second end and the head extends radially outward from the shaft.

Clause 19. The method of clause 18, wherein the head comprises a paddle, a disc, a ribbon, a ball, or any combination thereof.

Clause 20. The method of any of clauses 16-19, wherein the agitator is tubular and configured to maintain a first mixing zone and a separate second mixing zone within the vessel.

Clause 21. The method of any of clauses 16-20, wherein the agitator is a heat sink.

Clause 22. The method of any of clauses 16-21, wherein the agitator is an evaporative heat pipe.

Clause 23. The method of any of clauses 15-22, wherein a longitudinal axis of the agitator and a longitudinal axis of the vessel are offset with respect to each other.

Clause 24. The method of any of clauses 16-23, wherein the agitator remains stationary with respect to the vessel during mixing.

Clause 25. The method of any of clauses 16-23, wherein the agitator rotates with respect to the vessel during mixing.

Clause 26. A centrifugal mixer comprising: a housing defining a first longitudinal axis; a vessel positioned within the housing and the vessel defining a second longitudinal axis and the vessel comprises an agitator; a mount operatively coupled to the vessel and rotatably coupled to the housing; and a motor configured to revolve the vessel about the first longitudinal axis and rotate the vessel about the second longitudinal axis.

Clause 27. The centrifugal mixer of clause 26 further comprising a temperature control system in thermal communication with the vessel.

Clause 28. The centrifugal mixer of any of clauses 26-27, wherein the vessel comprises a body defining a vessel cavity and a lid configured to detachably engage the body, and the agitator is operatively coupled to the lid.

Clause 29. The centrifugal mixer of clause 28, wherein the agitator comprises a first end, a second end, and a shaft extending from the first end to the second end, wherein the first end is operatively coupled to the lid.

Clause 30. The centrifugal mixer of clause 29, wherein the agitator further comprises a head disposed adjacent to the second end and the head extends radially outward from the shaft.

Clause 31. The centrifugal mixer of clause 30, wherein the head comprises a paddle, a disc, a ribbon, a ball, or any combination thereof.

Clause 32. The centrifugal mixer of any of clauses 26-31, wherein the agitator is tubular and configured to maintain a first mixing zone and a separate second mixing zone within the vessel.

Clause 33. The centrifugal mixer of any of clauses 26-32, wherein the agitator is a heat sink.

Clause 34. The centrifugal mixer of any of clauses 26-33, wherein the agitator is an evaporative heat pipe.

Clause 35. The centrifugal mixer of any of clauses 26-34, wherein a longitudinal axis of the agitator and a longitudinal axis of the vessel are offset with respect to each other.

Clause 36. The centrifugal mixer of any of clauses 26-35, wherein the agitator remains stationary with respect to the vessel during mixing.

Clause 37. The centrifugal mixer of any of clauses 26-35, wherein the agitator rotates with respect to the vessel during mixing.

Clause 38. The centrifugal mixer of any of clauses 26-37 further comprising a second agitator.

As used herein, “at least one of” a list of elements means one of the elements or any combination of two or more of the listed elements. As an example “at least of A, B, and C” means A only; B only; C only; A and B; A and C; B and C; or A, B, and C.

Various features and characteristics are described in this specification to provide an understanding of the composition, structure, production, function, and/or operation of the invention, which includes the disclosed compositions, TIMs, assemblies, and methods. It is understood that the various features and characteristics of the invention described in this specification can be combined in any suitable manner, regardless of whether such features and characteristics are expressly described in combination in this specification. The Inventors and the Applicant expressly intend such combinations of features and characteristics to be included within the scope of the invention described in this specification. As such, the claims can be amended to recite, in any combination, any features and characteristics expressly or inherently described in, or otherwise expressly or inherently supported by, this specification. Furthermore, the Applicant reserves the right to amend the claims to affirmatively disclaim features and characteristics that may be present in the prior art, even if those features and characteristics are not expressly described in this specification. Therefore, any such amendments will not add new matter to the specification or claims and will comply with the written description, sufficiency of description, and added matter requirements. The various non-limiting embodiments disclosed and described in this specification can comprise, consist of, or consist essentially of the features and characteristics as variously described herein.

Any numerical range recited in this specification describes all sub-ranges of the same numerical precision (i.e., having the same number of specified digits) subsumed within the recited range. For example, a recited range of “1.0 to 10.0” describes all sub-ranges between (and including) the recited minimum value of 1.0 and the recited maximum value of 10.0, such as, for example, “2.4 to 7.6,” even if the range of “2.4 to 7.6” is not expressly recited in the text of the specification. Accordingly, the Applicant reserves the right to amend this specification, including the claims, to expressly recite any sub-range of the same numerical precision subsumed within the ranges expressly recited in this specification. All such ranges are inherently described in this specification such that amending to expressly recite any such sub-ranges will comply with the written description, sufficiency of description, and added matter requirements.

Also, unless expressly specified or otherwise required by context, all numerical parameters described in this specification (such as those expressing values, ranges, amounts, percentages, and the like) may be read as if prefaced by the word “about,” even if the word “about” does not expressly appear before a number. Additionally, numerical parameters described in this specification should be construed in light of the number of reported significant digits, numerical precision, and by applying ordinary rounding techniques. It is also understood that numerical parameters described in this specification will necessarily possess the inherent variability characteristic of the underlying measurement techniques used to determine the numerical value of the parameters.

Notwithstanding that numerical ranges and parameters setting forth the broad scope of the invention are approximations, numerical values set forth in the specific examples are reported precisely as possible. Any numerical value, however, inherently contains certain errors necessarily resulting from the standard variation found in its respective testing measurements.

Reference throughout the specification to “various examples,” “some examples,” “one example,” “an example,” or the like means that a particular feature, structure, or characteristic described in connection with the example is included in an example. Thus, appearances of the phrases “in various examples,” “in some examples,” “in one example,” “in an example,” or the like, in places throughout the specification are not necessarily all referring to the same example. Furthermore, the particular features, structures, or characteristics may be combined in any suitable manner in an example or examples. Thus, the particular features, structures, or characteristics illustrated or described in connection with one example may be combined, in whole or in part, with the features, structures, or characteristics of another example or other examples without limitation. Such modifications and variations are intended to be included within the scope of the present examples.

Any patent, publication, or other document identified in this specification is incorporated by reference into this specification in its entirety unless otherwise indicated but only to the extent that the incorporated material does not conflict with existing descriptions, definitions, statements, illustrations, or other disclosure material expressly set forth in this specification. As such, and to the extent necessary, the express disclosure as set forth in this specification supersedes any conflicting material incorporated by reference. Any material, or portion thereof, that is incorporated by reference into this specification, but which conflicts with existing definitions, statements, or other disclosure material set forth herein, is only incorporated to the extent that no conflict arises between that incorporated material and the existing disclosure material. Applicant reserves the right to amend this specification to expressly recite any subject matter, or portion thereof, incorporated by reference. The amendment of this specification to add such incorporated subject matter will comply with the written description, sufficiency of description, and added matter requirements.

Whereas particular examples of this invention have been described above for purposes of illustration, it will be evident to those skilled in the art that numerous variations of the details of the present invention may be made without departing from the invention as defined in the appended claims.

While the present disclosure provides descriptions of various specific aspects for the purpose of illustrating various aspects of the present disclosure and/or its potential applications, it is understood that variations and modifications will occur to those skilled in the art. Accordingly, the invention or inventions described herein should be understood to be at least as broad as they are claimed and not as more narrowly defined by particular illustrative aspects provided herein.

It is understood that the inventions described in this specification are not limited to the examples summarized in the Summary or Detailed Description. Various other aspects are described and exemplified herein.

What is claimed is:

1. A method for producing a thermal interface material, the method comprising:
combining a liquid metal and a polymer component to form an intermediate compound, wherein a melting point of the liquid metal is no greater than 30 degrees Celsius;
mixing the intermediate compound in a vessel of a centrifugal mixer, thereby forming liquid metal droplets from the liquid metal and dispersing the liquid metal droplets throughout the polymer component; and
controlling a temperature of the intermediate compound to be no greater than 30 degrees Celsius during the mixing.

2. The method of claim 1, wherein controlling the temperature of the intermediate compound comprises cooling.

3. The method of claim 1, wherein controlling the temperature of the intermediate compound is performed by controlling a temperature of a wall of the vessel.

4. The method of claim 3, wherein controlling a temperature of the wall of the vessel comprises solid state cooling the wall of the vessel.

5. The method of claim 3, wherein the wall of the vessel is metallic.

6. The method of claim 1, wherein the centrifugal mixer comprises a cavity and the vessel is disposed within the cavity, wherein controlling the temperature comprises controlling a temperature of the cavity.

7. The method of claim 6, wherein controlling the temperature of the cavity comprises forced air cooling.

8. The method of claim 1, wherein the intermediate compound is in a temperature range of 0 degrees Celsius to 30 degrees Celsius during the mixing.

9. The method of claim 1, wherein the thermal interface material comprises a viscosity in a range of 1,000 cP to 2,00 0,000 cP measured at 25 degrees Celsius.

10. The method of claim 1, wherein the liquid metal comprises at least one metal selected from the group consisting of gallium, a gallium alloy, indium, an indium alloy, tin, a tin alloy, mercury, and a mercury alloy.

11. The method of claim 1, wherein the polymer component comprises a polymer selected from the group consisting of an acrylic polymer, an acrylate polymer, a vinyl polymer, a polyester polymer, a polyurethane polymer, a polybutadiene polymer, a polyamide polymer, a polyether polymer, a polysiloxane polymer, a silicon hydride polymer, a fluoropolymer, a polyisoprene polymer, and a copolymer of any two or more thereof.

12. The method of claim 1, wherein the liquid metal droplets comprise a D₉₀ in a range of 1 micron to 300 microns.

13. The method of claim 1, wherein the vessel comprises an agitator.

14. The method of claim 1, wherein the centrifugal mixer is a dual axis centrifugal mixer.

15. A method for producing a thermal interface material, the method comprising:
combining a liquid metal and a polymer component to form an intermediate compound, wherein a melting point of the liquid metal is no greater than 30 degrees Celsius; and
mixing the intermediate compound in a vessel of a centrifugal mixer, thereby forming liquid metal droplets from the liquid metal and dispersing the liquid metal droplets throughout the polymer component, wherein the vessel comprises an agitator.

16. The method of claim 15, wherein the vessel comprises a body defining a vessel cavity configured to receive the intermediate compound and a lid configured to detachably engage the body, and the agitator is operatively coupled to the lid.

17. The method of claim 16, wherein the agitator comprises a first end, a second end, and a shaft extending from the first end to the second end, wherein the first end is operatively coupled to the lid.

18. The method of claim 17, wherein the agitator further comprises a head disposed adjacent to the second end and the head extends radially outward from the shaft.

19. The method of claim 18, wherein the head comprises a paddle, a disc, a ribbon, a ball, or any combination thereof.

20. The method of claim 16, wherein the agitator is tubular and configured to maintain a first mixing zone and a separate second mixing zone within the vessel.

21. The method of claim 16, wherein the agitator is a heat sink.

22. The method of claim 16, wherein the agitator is an evaporative heat pipe.

23. The method of claim 15, wherein a longitudinal axis of the agitator and a longitudinal axis of the vessel are offset with respect to each other.

24. The method of claim 16, wherein the agitator remains stationary with respect to the vessel during mixing.

25. The method of claim 16, wherein the agitator rotates with respect to the vessel during mixing.

26. A centrifugal mixer comprising:
a housing defining a first longitudinal axis;
a vessel positioned within the housing and the vessel defining a second longitudinal axis and the vessel comprises an agitator;
a mount operatively coupled to the vessel and rotatably coupled to the housing; and
a motor configured to revolve the vessel about the first longitudinal axis and rotate the vessel about the second longitudinal axis.

27. The centrifugal mixer of claim 26 further comprising a temperature control system in thermal communication with the vessel.

28. The centrifugal mixer of claim 26, wherein the vessel comprises a body defining a vessel cavity and a lid configured to detachably engage the body, and the agitator is operatively coupled to the lid.

29. The centrifugal mixer of claim 28, wherein the agitator comprises a first end, a second end, and a shaft extending from the first end to the second end, wherein the first end is operatively coupled to the lid.

30. The centrifugal mixer of claim 29, wherein the agitator further comprises a head disposed adjacent to the second end and the head extends radially outward from the shaft.

31. The centrifugal mixer of claim 30, wherein the head comprises a paddle, a disc, a ribbon, a ball, or any combination thereof.

32. The centrifugal mixer of claim 26, wherein the agitator is tubular and configured to maintain a first mixing zone and a separate second mixing zone within the vessel.

33. The centrifugal mixer of claim 26, wherein the agitator is a heat sink. 34 The centrifugal mixer of claim 26, wherein the agitator is an evaporative heat pipe.

35. The centrifugal mixer of claim 26, wherein a longitudinal axis of the agitator and a longitudinal axis of the vessel are offset with respect to each other.

36. The centrifugal mixer of claim 26, wherein the agitator remains stationary with respect to the vessel during mixing.

37. The centrifugal mixer of claim 26, wherein the agitator rotates with respect to the vessel during mixing.

38. The centrifugal mixer of claim 26 further comprising a second agitator.
